(19) United States
(12) Patent Application Publication
(10) Pub. No.: US 2016/0200182 A1
(43) Pub. Date: Jul. 14, 2016

(54) PANEL JOINT STRUCTURE

(71) Applicant: TOYOTA JIDOSHA KABUSHIKI KAISHA, Toyota-shi, Aichi (JP)

(72) Inventors: Satoshi OGAWA, Toyota-shi (JP); Atsushi MIKUNI, Toyota-shi (JP)

(73) Assignee: TOYOTA JIDOSHA KABUSHIKI KAISHA, Toyota-shi, Aichi (JP)

(21) Appl. No.: 14/911,936

(22) PCT Filed: Aug. 12, 2014
(86) PCT No.: PCT/JP2014/071815

§ 371 Date: Feb. 12, 2016

(30) Foreign Application Priority Data
Sep. 9, 2013 (JP) 2013-186306

(51) Int. Cl. B60J 5/04; B21D 39/02; F16B 11/00

(52) U.S. Cl. CPC B60J 5/0469; F16B 11/006; B21D 39/028

(57) ABSTRACT

A panel joint structure 10 includes: a first panel member 14 that has a first joint portion 14A; a second panel member 16 that is formed of a material having a coefficient of linear expansion different from that of the first panel member 14 and has a second joint portion 16A joined by an elastic adhesive G to the first joint portion 14A; and a projecting portion 18 that is disposed on the second joint portion 16A and contacts the first joint portion 14A to thereby form an interstice S for filling a space between the first joint portion 14A and the second joint portion 16A with the elastic adhesive G.

### TECHNICAL FIELD

The present invention relates to a panel joint structure.

### BACKGROUND ART

A hemmed portion is sometimes formed in an end portion of an outer panel having a coefficient of thermal expansion greater than that of an inner panel. Vehicle doors in which the hemmed portion is joined to an end portion of the inner panel by an adhesive that cures at a temperature 50° C. or more lower than the baking temperature-after electrodeposition painting have conventionally been known (e.g., see Japanese Patent Application Laid-Open (JP-A) No. 2012-140058).

### SUMMARY OF INVENTION

### Technical Problem

However, if the thickness of the adhesive layer joining together the inner panel and the outer panel is not fixed, there is the concern that when the outer panel thermally expands in a high temperature environment, the strain of the outer panel relative to that of the inner panel will vary. In this way, there has been room for improvement when it comes to a structure for suppressing strain caused by relative movement resulting from a difference in thermal expansion between one panel and another panel having different coefficients of linear expansion.

Therefore, it is an object of the present invention to obtain a panel joint structure in which the thickness of an adhesive joining together one panel member and another panel member can be fixed.

### Solution to Problem

In order to achieve the above object, a panel joint structure pertaining to a first aspect of the present invention includes: a first panel member that has a first joint portion; a second panel member that is formed of a material having a coefficient of linear expansion different from that of the first panel member and has a second joint portion joined by an elastic adhesive to the first joint portion; and a projecting portion that is disposed on the second joint portion and contacts the first joint portion to thereby form an interstice for filling a space between the first joint portion and the second joint portion with the elastic adhesive.

According to the panel joint structure pertaining to the first aspect, the projecting portion that forms the interstice for filling the space between the first joint portion and the second joint portion with the elastic adhesive by contacting the first joint portion is disposed on the second joint portion. Consequently, the thickness of the adhesive layer joining together the first joint portion (the first panel member) and the second joint portion (the second panel member) is fixed, and relative strain of the joint surface caused by relative movement resulting from a difference in thermal expansion between the first panel member and the second panel member having different coefficients of linear expansion is suppressed.

A panel joint structure pertaining to a second aspect of the present invention is the panel joint structure pertaining to the first aspect, wherein the first joint portion is formed on an edge portion of the first panel member, the second joint portion is formed on an edge portion of the second panel member, one of either of the first joint portion or the second joint portion is made into a hemmed portion that is folded back and fixed to the other of either of the first joint portion or the second joint portion, and the projecting portion is disposed inside the hemmed portion.

According to the panel joint structure pertaining to the second aspect, the first joint portion of the first panel member and the second joint portion of the second panel member are joined together by hemming, and the projecting portion is disposed inside the hemmed portion. That is, the interstice for filling with the elastic adhesive is formed inside the hemmed portion. Consequently, the thickness of the adhesive layer joining together the first joint portion (the first panel member) and the second joint portion (the second panel member) is efficiently fixed.

A panel joint structure pertaining to a third aspect of the present invention is the panel joint structure pertaining to the second aspect, wherein the projecting portion is given a configuration that allows the first joint portion or the second joint portion to be disposed in a thickness direction center portion inside the hemmed portion.

According to the panel joint structure pertaining to the third aspect, because of the projecting portion, the first joint portion or the second joint portion is disposed in the thickness direction center portion inside the hemmed portion. That is, the interstice for filling with the elastic adhesive is formed inside the hemmed portion on both sides of the first joint portion or the second joint portion. Consequently, the thickness of the adhesive layer joining together the first joint portion (the first panel member) and the second joint portion (the second panel member) is precisely fixed. The “center portion” in the present invention includes not only the exact center portion but also a substantial center portion slightly shifted from the exact center portion.

A panel joint structure pertaining to a fourth aspect of the present invention is the panel joint structure according to any one of the first to third aspects, wherein the projecting portion is given a configuration in which it maintains its state of contact with respect to the first joint portion even when the first panel member or the second panel member thermally expands.

According to the panel joint structure pertaining to the fourth aspect, the state of contact of the projecting portion with respect to the first joint portion is maintained even when the first panel member or the second panel member thermally expands. Consequently, when the first panel member or the second panel member returns to its original state after thermal expansion, the return is prevented from being inhibited by the projecting portion.

A panel joint structure pertaining to a fifth aspect of the present invention is the panel joint structure according to any one of the first to fourth aspects, wherein plural beads are mixed into the elastic adhesive.

According to the panel joint structure pertaining to the fifth aspect, the plural beads are mixed into the elastic adhesive. Consequently, the thickness of the adhesive layer joining together the first joint portion (the first panel member) and the second joint portion (the second panel member) does not become thinner than the diameter of the beads. Because of this, the thickness of the adhesive layer can be more reliably fixed.

### Advantageous Effects of Invention

As described above, according to the panel joint structure pertaining to the first aspect of the present invention, the thickness of the adhesive layer joining together the first panel member and the second panel member can be fixed.

According to the panel joint structure pertaining to the second aspect of the present invention, the thickness of the adhesive layer joining together the first panel member and the second panel member can be efficiently fixed.

According to the panel joint structure pertaining to the third aspect of the present invention, the thickness of the adhesive layer joining together the first panel member and the second panel member can be precisely fixed.

According to the panel joint structure pertaining to the fourth aspect of the present invention, when the first panel member or the second panel member returns to its original state after thermal expansion, the return can be prevented from being inhibited by the projecting portion.

According to the panel joint structure pertaining to the fifth aspect of the present invention, the thickness of the adhesive layer joining together the first panel member and the second panel member can be more reliably fixed.

### BRIEF DESCRIPTION OF DRAWINGS

FIG. 1 is a side view showing a front side door equipped with a panel joint structure pertaining to embodiments;

FIG. 2 is a sectional view, taken along line X-X in FIG. 1 and seen from the direction of the arrows, showing a panel joint structure pertaining to a first embodiment;

FIG. 3 is a perspective view showing projecting portions formed on an inner panel of the front side door;

FIG. 4A is a sectional view corresponding to FIG. 2 showing a normal state of the panel joint structure pertaining to the first embodiment;

FIG. 4B is a sectional view corresponding to FIG. 2 showing a thermally expanded state of the panel joint structure pertaining to the first embodiment;

FIG. 5 is a sectional view corresponding to FIG. 2 showing an example modification in which the position of the projecting portions of the panel joint structure pertaining to the first embodiment is changed;

FIG. 6 is a sectional view corresponding to FIG. 2 showing an example modification of an adhesive of the panel joint structure pertaining to the first embodiment;

FIG. 7 is a sectional view, taken along line X-X in FIG. 1 and seen from the direction of the arrows, showing a panel joint structure pertaining to a second embodiment;

FIG. 8 is a sectional view, taken along line X-X in FIG. 1 and seen from the direction of the arrows, showing a panel joint structure pertaining to a third embodiment;

FIG. 9 is a sectional view, taken along line X-X in FIG. 1 and seen from the direction of the arrows, showing a panel joint structure pertaining to a fourth embodiment;

FIG. 10 is a sectional view showing a panel joint structure pertaining to a fifth embodiment;

FIG. 11A is a sectional view showing a normal state of a front side door of a first comparative example;

FIG. 11B is a sectional view showing a thermally expanded state of the front side door of the first comparative example;

FIG. 12A is a sectional view showing a normal state of a front side door of a second comparative example; and

FIG. 12B is a sectional view showing a thermally expanded state of the front side door of the second comparative example.

### DESCRIPTION OF EMBODIMENTS

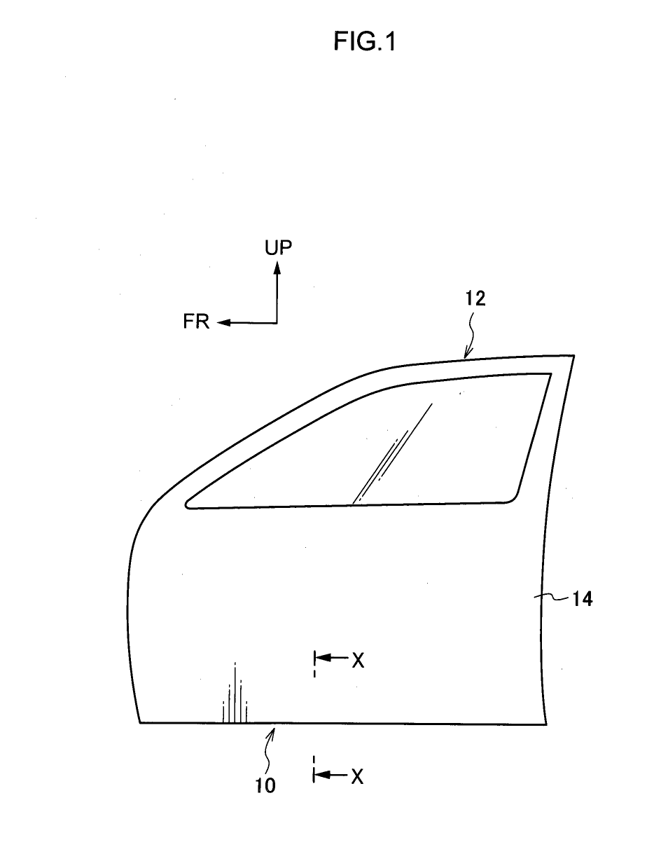

Embodiments of the present invention will be described in detail below on the basis of the drawings. For convenience of description, a case where a panel joint structure 10 pertaining to the embodiments is applied to a front side door 12 shown in FIG. 1 will be taken as an example. Arrow UP appropriately shown in the drawings indicates a door upper direction, arrow FR indicates a door front direction, and arrow OUT indicates outward in a door thickness direction.

Furthermore, in the description below, in the case of using the directions of upper and lower, front and rear, and inner and outer, unless otherwise noted these indicate upper and lower in the door up and down direction, front and rear in the door front and rear direction, and inner and outer in the door thickness direction (vehicle width direction). Furthermore, surfaces facing inward in the door thickness direction are called “inner surfaces” and surfaces facing outward in the door thickness direction are called “outer surfaces.” For example, a later-described inner wall 26 has an “outer surface 26A” even though it is inside a hemmed portion 20.

### First Embodiment

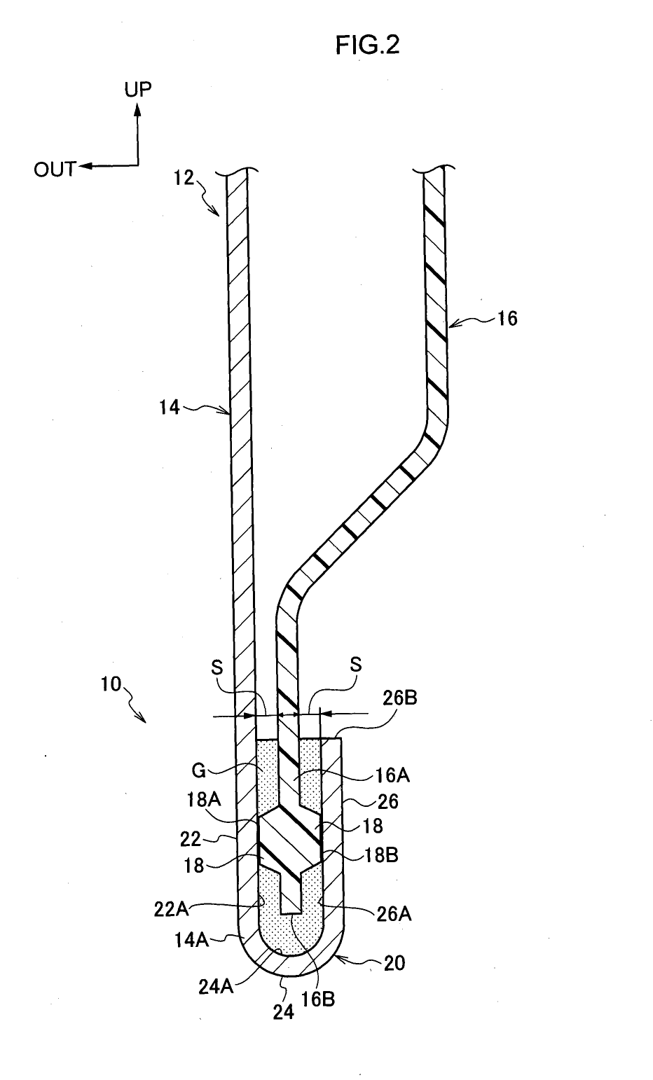

First, a first embodiment will be described. As shown in FIG. 1 and FIG. 2, the front side door 12 has an outer panel 14, which serves as a first panel member and is disposed on the door thickness direction outside (vehicle width direction outside), and an inner panel 16, which serves as a second panel member and is disposed on the door thickness direction inside (vehicle width direction inside). The outer panel 14 and the inner panel 16 are panel-like stamped parts extending in the vehicle up and down direction and the vehicle front and rear direction and are formed of materials having different coefficients of linear expansion (coefficients of thermal expansion).

For example, the outer panel 14 is formed of a metal material such as aluminum alloy, and the inner panel 16 is formed of a fiber reinforced plastic (FRP) material and more specifically a carbon fiber reinforced plastic (CFRP) material. That is, the outer panel 14 is formed of a material having a coefficient of linear expansion greater than that of the inner panel 16 (in other words, the inner panel 16 is formed of a material having a coefficient of linear expansion smaller than that of the outer panel 14).

The outer panel 14 and the inner panel 16 are not limited to being formed of the above materials. For example, the outer panel 14 and the inner panel 16 may also be formed of two types of metal materials having different coefficients of linear expansion (with the coefficient of linear expansion of the outer panel 14 being greater than the coefficient of linear expansion of the inner panel 16) or may also be formed of two types of (fiber reinforced) plastic materials having different coefficients of linear expansion (with the coefficient of linear expansion of the outer panel 14 being greater than the coefficient of linear expansion of the inner panel 16).

Furthermore, a lower end portion (edge portion) 14A serving as an example of a first joint portion of the outer panel 14 is folded back and fixed to a flange-like lower end portion (edge portion) 16A serving as an example of a second joint portion of the inner panel 16. Specifically, the lower end portion 14A of the outer panel 14 is joined to the lower end portion 16A of the inner panel 16 by joining means including hemming.

As shown in FIG. 2, the lower end portion 14A side of the outer panel 14 is folded back toward the door inner and upper side as seen in a sectional view seen from the door front and rear direction, so that later-described projecting portions 18 projectingly disposed on both faces of the lower end portion 16A of the inner panel 16 are sandwiched from inside and outside in the door thickness direction by the lower end portion 14A side of the outer panel 14. That is, the lower end portion 14A of the outer panel 14 is made into a hemmed portion 20 that sandwiches in the door thickness direction the projecting portions 18 projectingly disposed on both faces of the lower end portion 16A of the inner panel 16.

In the hemmed portion 20, the part of the lower end portion 14A that is folded back and disposed on the door inside is made into an inner wall 26, and the part of the lower end portion 14A that opposes the inner wall 26 in the door thickness direction (is disposed on the door outside) is made into an outer wall 22. Additionally, the part of the lower end portion 14A located between the outer wall 22 and the inner wall 26 is made into a bottom wall 24. Consequently, “inside the hemmed portion 20” refers to the space configured (surrounded) by the outer wall 22, the bottom wall 24, and the inner wall 26.

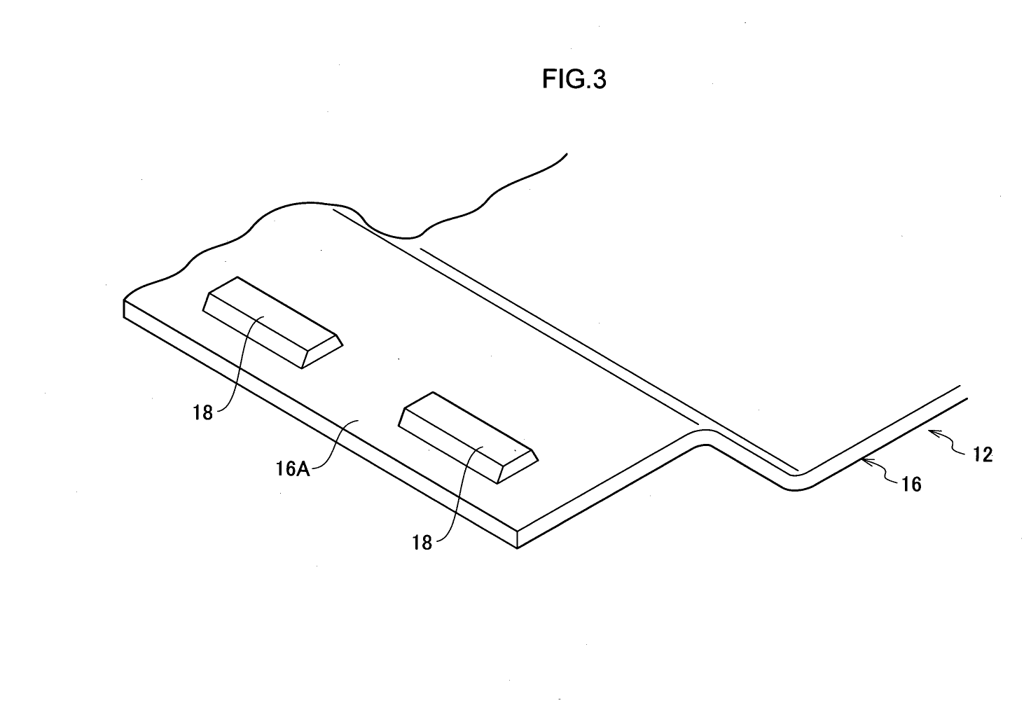

As shown in FIG. 2 and FIG. 3, at least the lower end portion 16A side of the inner panel 16 is formed in a substantially flat panel shape. Additionally, plural projecting portions 18 that project inward and outward in the door thickness direction in the shape of a substantially pyramidal frustum are integrally projectingly disposed at the same height and at predetermined intervals apart from one another (e.g., at equidistant intervals) in the door front and rear direction in the same positions on both faces (the inner surface and the outer surface) of the lower end portion 16A side of the inner panel 16.

Consequently, the lower end portion 16A of the inner panel 16 is disposed in a thickness direction substantial center portion inside the hemmed portion 20. That is, inside the hemmed portion 20, interstices S having substantially the same width in the door thickness direction are formed between the outer surface of the lower end portion 16A of the inner panel 16 (excluding the projecting portions 18) and an inner surface 22A of the outer wall 22 and between the inner surface of the lower end portion 16A of the inner panel 16 (excluding the projecting portions 18) and an outer surface 26A of the inner wall 26.

Additionally, the interstices S (inside spaces) are filled with an elastic adhesive G That is, the outer surface of the lower end portion 16A of the inner panel 16 (excluding the projecting portions 18) and the inner surface 22A of the outer wall 22, and the inner surface of the lower end portion 16A of the inner panel 16 (excluding the projecting portions 18) and the outer surface 26A of the inner wall 26, are joined together by hemming and the elastic adhesive G.

Because of these joining means, the joint strength between the lower end portion 14A (the hemmed portion 20) of the outer panel 14 and the lower end portion 16A of the inner panel 16 is ensured. Examples of the elastic adhesive G include urethane adhesives that are extensible (elastically deformable) even after they have been cured. Furthermore, the interstices S (the height of the projecting portions 18) are appropriately decided by calculating the thickness of the adhesive layer resulting from the elastic adhesive G that can absorb a later-described difference in thermal expansion.

Furthermore, the shape of the projecting portions 18 for ensuring the interstices S is not limited to the shape shown in the drawings, and the projecting portions 18 may also be formed in a conical frustum shape or a hemispherical shape, for example. Moreover, the projecting portions 18 may also be formed continuously in the door front and rear direction. That is, it suffices for the shape of the projecting portions 18 to be a shape (size) that can ensure a joint area resulting from the elastic adhesive G between the lower end portion 14A (the hemmed portion 20) of the outer panel 14 and the lower end portion 16A of the inner panel 16.

Furthermore, outer surfaces 18A of the projecting portions 18 and the inner surface 22A of the outer wall 22, and inner surfaces 18B of the projecting portions 18 and the outer surface 26A of the inner wall 26, slidably contact one another and are not joined together. That is, the lower end portion 14A (the hemmed portion 20) of the outer panel 14 is not restrained by the lower end portion 16A of the inner panel 16.

Furthermore, as shown in FIG. 2, the projecting portions 18 are projectingly disposed near a lower end surface 16B of the inner panel 16. In other words, the projecting portions 18 are disposed in the hemmed portion 20 between an upper end surface 26B of the inner wall 26 and an inner surface 24A of the bottom wall 24 and nearer to the inner surface 24A of the bottom wall 24 than the depth direction (door up and down direction) center portion of the hemmed portion 20. That is, both the upper and lower sides of the projecting portions 18 are filled with the elastic adhesive G.

Next, the action of the panel joint structure 10 pertaining to the first embodiment given the above configuration will be described.

In a case where the front side door 12 is configured by joining together the outer panel 14 and the inner panel 16 that are formed of materials having different coefficients of linear expansion, it is easy for a difference in thermal expansion to occur between the outer panel 14 and the inner panel 16 in a high temperature environment such as, for example, in the painting step at the time of vehicle manufacture (in the case of the painting step, the temperature rises to around 180° C.).

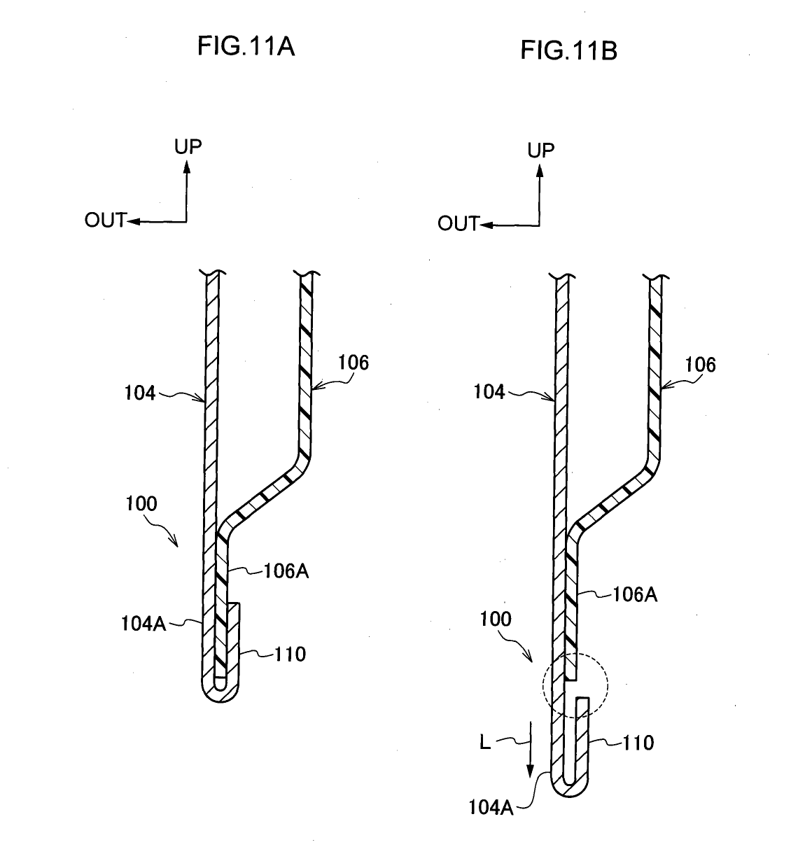

Here, a panel joint structure 100 pertaining to a first comparative example shown in FIG. 11A and FIG. 11B will be described, and the coefficient of linear expansion of an outer panel 104 formed of a metal material is greater than the coefficient of linear expansion of an inner panel 106 formed of a fiber reinforced plastic (FRP) material. Consequently, in a high temperature environment such as described above, a difference in thermal expansion occurs between the outer panel 104 and the inner panel 106, and a lower end portion 104A of the outer panel 104 becomes extended in the direction of arrow L relative to a lower end portion 106A of the inner panel 106.

For that reason, there is the concern that a hemmed portion 110 configuring the lower end portion 104A of the outer panel 104 will come apart (undergo hem displacement) from the lower end portion 106A of the inner panel 106. An adhesive is not disposed inside the hemmed portion 110 shown in FIG. 11A; so the lower end portion 104A of the outer panel 104 is joined to the lower end portion 106A of the inner panel 106 only by hemming Furthermore, FIG. 11B exaggeratedly depicts the hem displacement of the lower end portion 104A of the outer panel 104 relative to the lower end portion 106A of the inner panel 106.

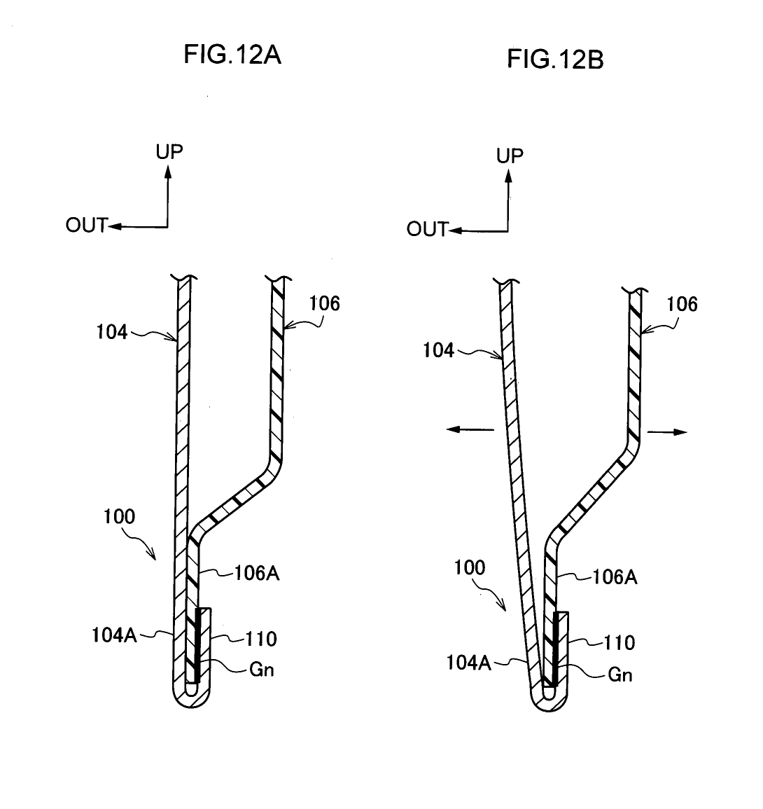

Furthermore, if, like in the panel joint structure 100 pertaining to a second comparative example shown in FIG. 12A and FIG. 12B, the hemmed portion 110 configuring the lower end portion 104A of the outer panel 104 is joined by an inelastic adhesive Gn to the lower end portion 106A of the inner panel 106, due to the difference in thermal expansion between the inner panel 106 and the outer panel 104, the outer panel 104 and the inner panel 106 become deformed in directions away from one another in a state in which the hemmed portion 110 of the outer panel 104 and the lower end portion 106A of the inner panel 106 are restrained. For that reason, there is the concern that surface strain will occur between the outer panel 104 and the inner panel 106.

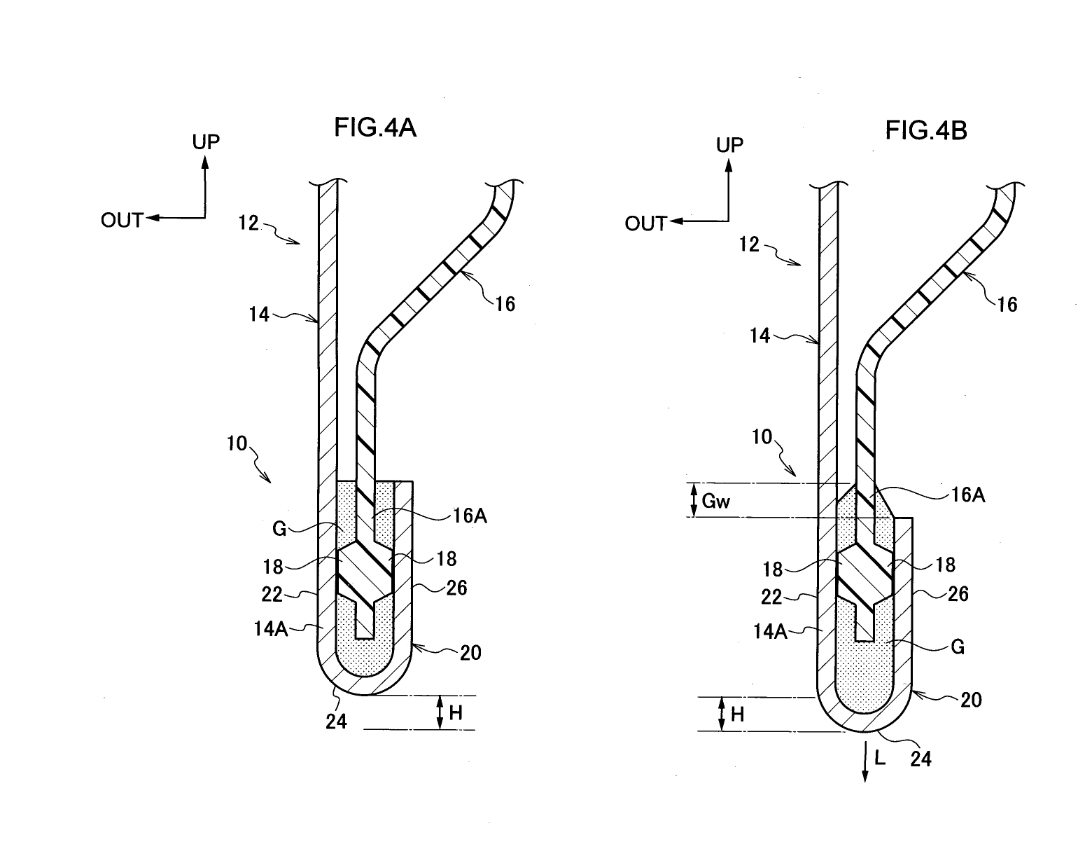

In contrast, in the panel joint structure 10 pertaining to the present embodiment, as shown in FIG. 2, FIG. 4A, and FIG. 4B, the hemmed portion 20 configuring the lower end portion 14A of the outer panel 14 is joined by the elastic adhesive G to the lower end portion 16A of the inner panel 16. Additionally, the projecting portions 18 that form the interstices S for filling with the elastic adhesive G are projectingly disposed inside the hemmed portion 20 on both faces of the lower end portion 16A of the inner panel 16.

That is, because of the projecting portions 18 disposed inside the hemmed portion 20, the lower end portion 16A of the inner panel 16 is disposed in the thickness direction substantial center portion inside the hemmed portion 20, and space portions (the interstices S) for filling with the elastic adhesive G are formed on both sides of the lower end portion 16A. Consequently, the thickness of the adhesive layer resulting from the elastic adhesive G joining together the hemmed portion 20 of the outer panel 14 and the lower end portion 16A of the inner panel 16 is efficiently and precisely fixed (stabilized).

Additionally, the outer surfaces 18A of the projecting portions 18 and the inner surface 22A of the outer wall 22, and the inner surfaces 18B of the projecting portions 18 and the outer surface 26A of the inner wall 26, are not joined to one another, so that the lower end portion 14A (the hemmed portion 20) of the outer panel 14 is not directly restrained by the lower end portion 16A of the inner panel 16.

Thus, as shown in FIG. 4A and FIG. 4B, the inner panel 16 does not inhibit the hemmed portion 20 (the lower end portion 14A) of the outer panel 14 from being extended by thermal expansion in the direction of arrow L relative to the lower end portion 16A of the inner panel 16 as seen in a sectional view seen from the door front and rear direction, and when the hemmed portion 20 of the outer panel 14 has been extended (when strain H has occurred), the elastic adhesive G can follow suit and be extended (elastically deformed).

That is, the extension (strain H) of the outer panel 14 is absorbed by the extension Gw of the elastic adhesive G Consequently, the hemmed portion 20 of the outer panel 14 is suppressed or prevented from coming apart (undergoing hem displacement) from the lower end portion 16A of the inner panel 16. Additionally, the occurrence of surface strain between both panels resulting from the outer panel 14 and the inner panel 16 being deformed in directions away from one another is suppressed or prevented.

Furthermore, as shown in FIG. 2, FIG. 4A, and FIG. 4B, the projecting portions 18 are projectingly disposed near the lower end surface 16B of the inner panel 16. That is, the projecting portions 18 are disposed nearer to the inner surface 24A of the bottom wall 24 than the depth direction (door up and down direction) center portion of the hemmed portion 20. Consequently, when the outer panel 24 returns to its original state in a room temperature environment, there is no concern that the return will be inhibited by the projecting portions 18.

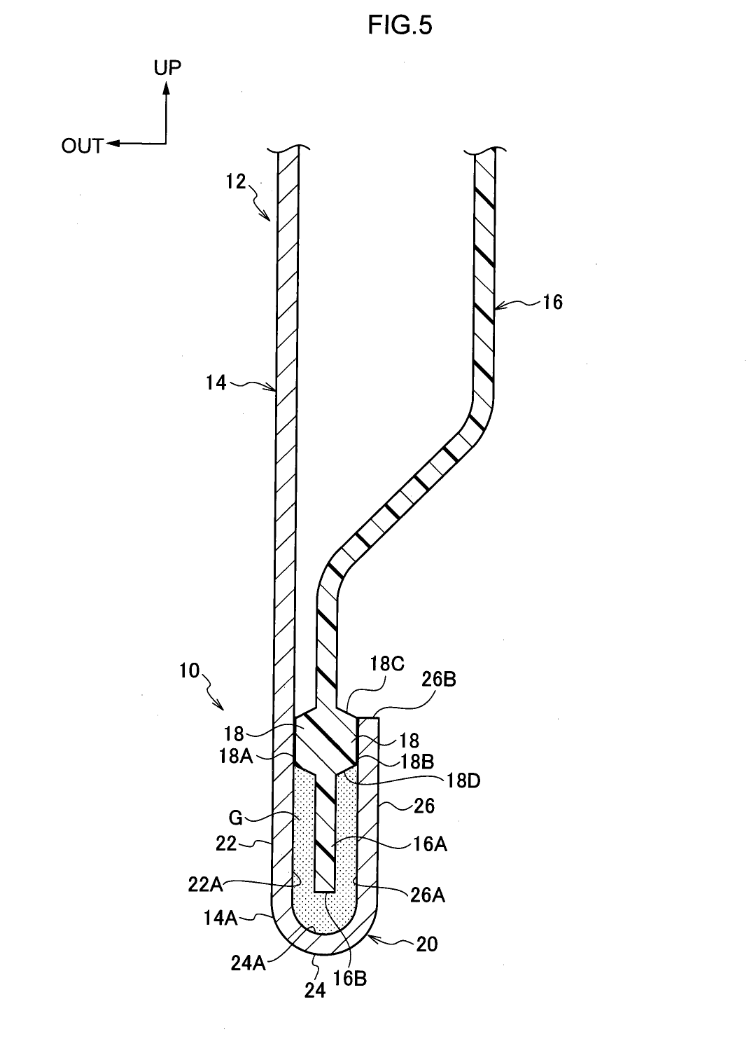

To describe this in detail, as shown in FIG. 5 for example, if the projecting portions 18 are projectingly disposed in a position on the upper side of the position shown in FIG. 2, FIG. 4A, and FIG. 4B (a position in which upper end surfaces 18C of the projecting portions 18 become even with the upper end surface 26B of the inner wall 26), there is the concern that the projecting portions 18 will relatively escape from the hemmed portion 20 when the outer panel 14 has been extended relative to the inner panel 16 by thermal expansion. In this case, when the outer panel 14 returns to its original state in a room temperature environment, there is the concern that lower end surfaces 18D of the projecting portions 18 on the door inside will interfere with the upper end surface 26B of the inner wall 26 and end up inhibiting the return of the outer panel 14.

However, as shown in FIG. 2, FIG. 4A, and FIG. 4B, if the projecting portions 18 are disposed nearer to the inner surface 24A of the bottom wall 24 than the depth direction center portion of the hemmed portion 20, the projecting portions 18 are suppressed or prevented from escaping from the hemmed portion 20 (the state of contact of the projecting portions 18 with respect to the outer wall 22 and the inner wall 26 is maintained) even when the outer panel 14 is extended relative to the inner panel 16 by thermal expansion. Thus, the return of the outer panel 14 is prevented from being inhibited by the projecting portions 18.

The projecting portions 18 may also be projectingly disposed in the position on the upper side described above (a position in which the upper end surfaces 18C become even with the upper end surface 26B) provided that they have a configuration that does not inhibit the return of the outer panel 14, such as the lower end surfaces 18D of the projecting portions 18 being formed as tapered surfaces having a gentle angle that does not interfere with the upper end surface 26B of the inner wall 26. Furthermore, if the projecting portions 18 projectingly disposed in the position on the upper side are formed continuously in the door front and rear direction, there is no concern that the elastic adhesive G before curing will leak out from the inside of the hemmed portion 20.

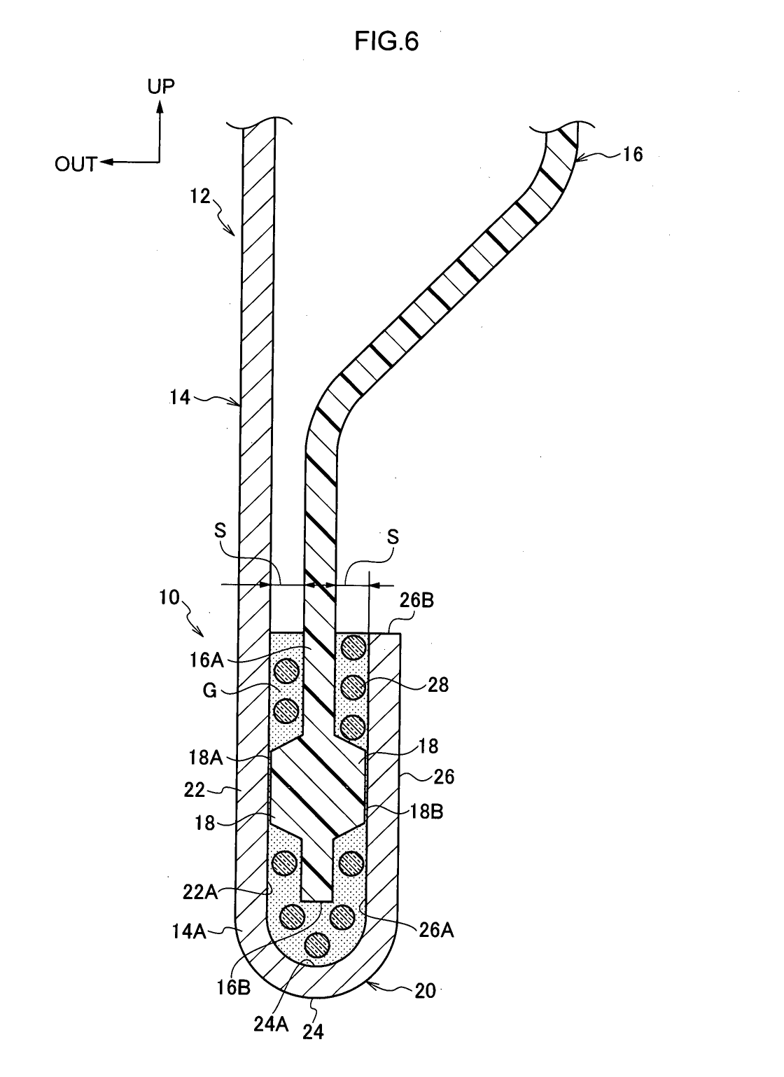

Moreover, as shown in FIG. 6, plural spherical beads 28 made of glass and having a smaller diameter than the interstices S may also be mixed into the elastic adhesive G According to this, the interstices S in the depth direction (door up and down direction) of the hemmed portion 20 do not become thinner than the beads 28. Consequently, the interstices S can be formed more uniformly, so the thickness of the adhesive layer resulting from the elastic adhesive G can be more reliably fixed (stabilized). The beads 28 are not limited to being made of glass.

Furthermore, because the elastic adhesive G is an adhesive that is elastically deformable (extensible) even after it has been cured, it is preferred that the elastic adhesive G be cured beforehand before the front side door 12 (the outer panel 14 and the inner panel 16) is placed in a high temperature environment. Because of this, leaking of the elastic adhesive G from the inside of the hemmed portion 20 when the front side door 12 has been placed in a high temperature environment can be prevented.

### Second Embodiment

Next, a second embodiment will be described. The same reference signs will be assigned to parts that are equivalent to those in the first embodiment, and detailed description (also including shared action) will be omitted.

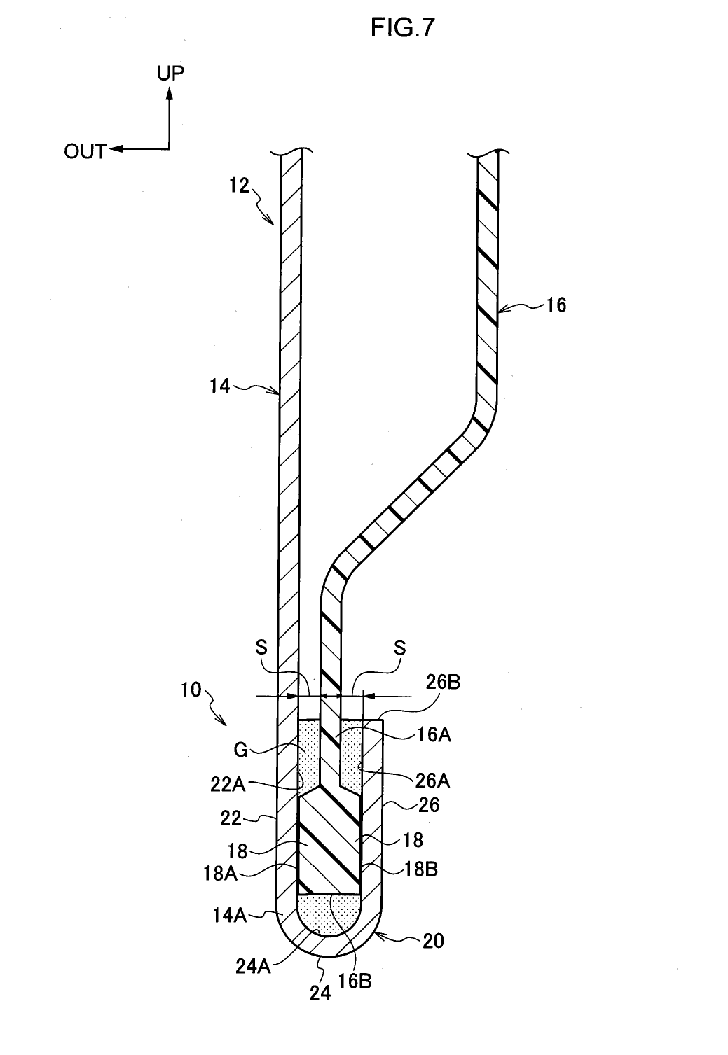

As shown in FIG. 7, in the panel joint structure 10 pertaining to the second embodiment, the shape of the projecting portions 18 differs from the shape of the projecting portions 18 in the first embodiment. Specifically, the projecting portions 18 are formed long in the up and down direction until they reach the lower end surface 16B of the lower end portion 16A of the inner panel 16. With these projecting portions 18, the interstices S can be formed more uniformly in the depth direction (door up and down direction) inside the hemmed portion 20, so the thickness of the adhesive layer resulting from the elastic adhesive G can be more reliably and precisely fixed (stabilized).

### Third Embodiment

Next, a third embodiment will be described. The same reference signs will be assigned to parts that are equivalent to those in the first embodiment and the second embodiment, and detailed description (also including shared action) will be omitted.

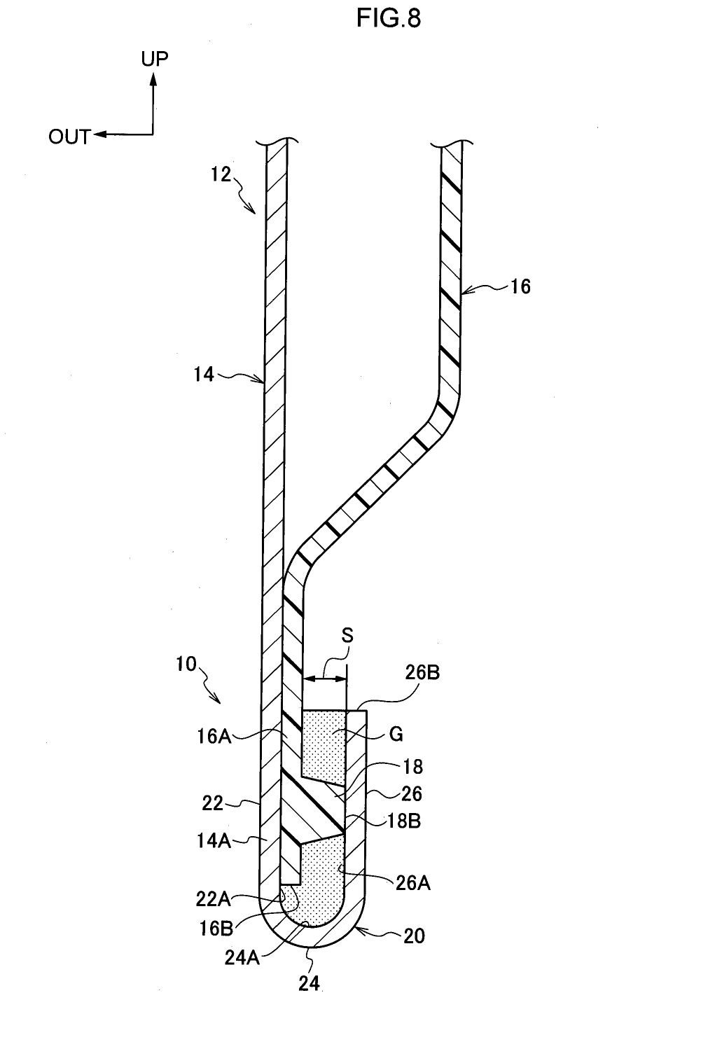

As shown in FIG. 8, in the panel joint structure 10 pertaining to the third embodiment, the projecting portions 18 have a configuration in which they are projectingly disposed only on the inner surface side (one surface side) of the lower end portion 16A of the inner panel 16 (a configuration in which the projecting portions 18 are not projectingly disposed on the outer surface side of the lower end portion 16A of the inner panel 16).

Specifically, the outer surface of the lower end portion 16A of the inner panel 16 is in contact with the inner surface 22A of the outer wall 22 configuring the lower end portion 14A (the hemmed portion 20) of the outer panel 14, and the inner surfaces 18B of the projecting portions 18 are in contact with the outer surface 26A of the inner wall 26 configuring the lower end portion 14A (the hemmed portion 20) of the outer panel 14.

Because of this, an interstice S for filling with the elastic adhesive G is formed only between the inner surface of the lower end portion 16A of the inner panel 16 and the outer surface 26A of the inner wall 26 configuring the lower end portion 14A (the hemmed portion 20) of the outer panel 14. Additionally, because of the elastic adhesive G filling the interstice S, the inner surface of the lower end portion 16A of the inner panel 16 (excluding the projecting portions 18) and the outer surface 26A of the inner wall 26 are joined together.

The inner surfaces 18B of the projecting portions 18B and the outer surface 26A of the inner wall 26 have a configuration in which they are not joined together. Additionally, the outer surface of the lower end portion 16A of the inner panel 16 also has a configuration in which it is not joined to the inner surface 22A of the outer wall 22. Because of this, the extension of the outer panel 14 relative to the inner panel 16 resulting from thermal expansion is not inhibited by the inner panel 16.

### Fourth Embodiment

Next, a fourth embodiment will be described. The same reference signs will be assigned to parts that are equivalent to those in the first embodiment to the third embodiment, and detailed description (also including shared action) will be omitted.

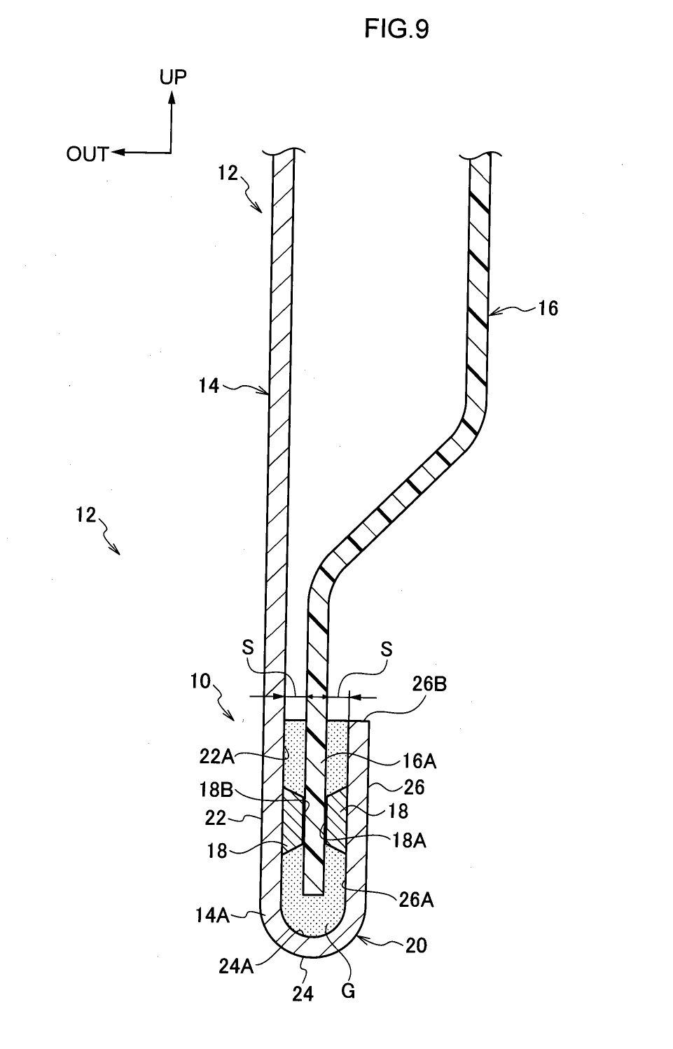

As shown in FIG. 9, in the panel joint structure 10 pertaining to the fourth embodiment, the plural projecting portions 18 are projectingly disposed at the same height and at predetermined intervals (e.g., at equidistant intervals) apart from one another in the door front and rear direction, and in such a way as to oppose one another in the door thickness direction, not on the lower end portion 16A of the inner panel 16 but on the inner surface 22A of the outer wall 22 and the outer surface 26A of the inner wall 26 configuring the lower end portion 14A (the hemmed portion 20) of the outer panel 14.

Specifically, each of the projecting portions 18 is, for example, formed of the same metal material as the outer panel 14 and as a separate body in the shape of a substantially pyramidal frustum and is joined by joining means, such as being fastened by a bolt or welded, to the inner surface 22A of the outer wall 22 and the outer surface 26A of the inner wall 26. Additionally, the lower end portion 16A of the inner panel 16 is inserted between the projecting portions 18 opposing one another in the door thickness direction, and interstices S for filling with the elastic adhesive G are formed on both sides of the lower end portion 16A.

Because of the elastic adhesive G filling the interstices S, the outer surface of the lower end portion 16A of the inner panel 16 and the inner surface 22A of the outer wall 22 (excluding the projecting portions 18) are joined together and the inner surface of the lower end portion 16A of the inner panel 16 and the outer surface 26A of the inner wall 26 (excluding the projecting portions 18) are joined together.

In the fourth embodiment, because the projecting portions 18 are projectingly disposed on the lower end portion 14A of the outer panel 14, the inner panel 16 becomes the first panel member and the lower end portion 16A thereof becomes the first joint portion. Additionally, the outer panel 14 becomes the second panel member and the lower end portion 14A thereof (the hemmed portion 20) becomes the second joint portion.

Furthermore, in the fourth embodiment, the inner surfaces 18B and the outer surfaces 18A of the projecting portions 18 opposing one another in the door thickness direction have a configuration in which they are not joined to the outer surface and the inner surface of the lower end portion 16A of the inner panel 16. Because of this, the extension of the outer panel 14 relative to the inner panel 16 resulting from thermal expansion is not inhibited by the inner panel 16.

### Fifth Embodiment

Finally, a fifth embodiment will be described. The same reference signs will be assigned to parts that are equivalent to those in the first embodiment to the fourth embodiment, and detailed description (also including shared action) will be omitted.

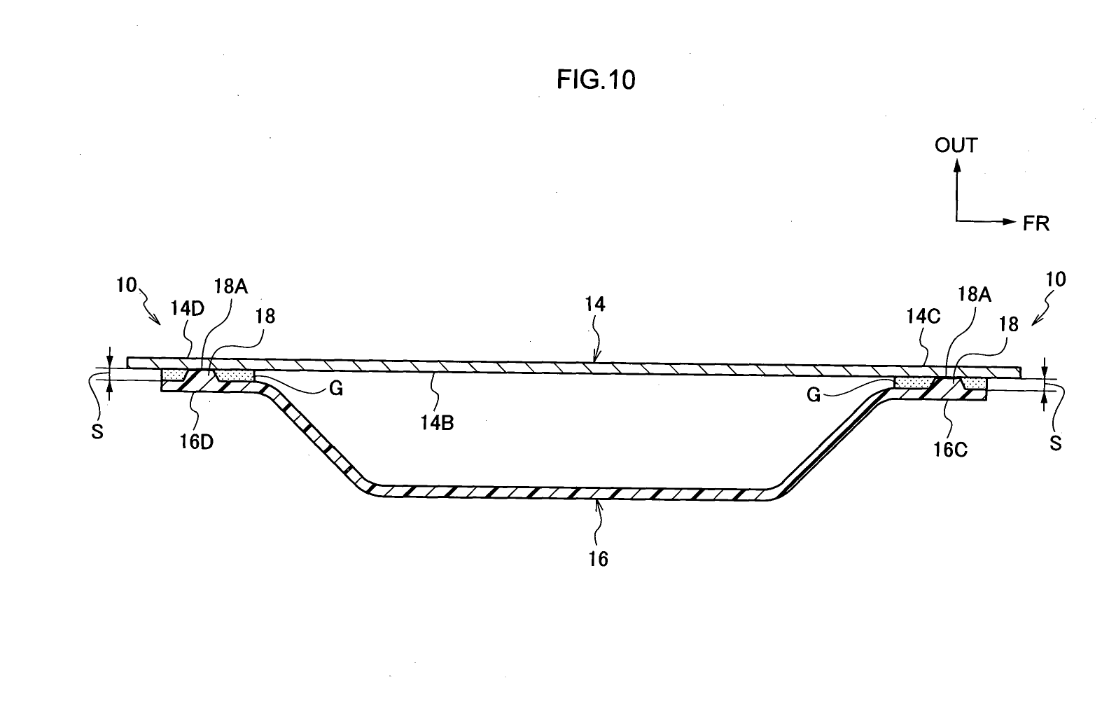

As shown in FIG. 10, the panel joint structure 10 pertaining to the fifth embodiment has a configuration in which the hemmed portion 20 is not formed in the edge portion of the outer panel 14. Specifically, the projecting portions 18 are projectingly disposed only on a front end portion 16C and a rear end portion 16D serving as second joint portions of the inner panel 16, and the outer surfaces 18A of the projecting portions 18 are in contact with an inner surface 14B of the outer panel 14 at a front end portion 14C and a rear end portion 14D serving as first joint portions.

Because of this, interstices S for disposing the elastic adhesive G are formed between the outer surface of the inner panel 16 at the front end portion 16C and the rear end portion 16D and the inner surface 14B of the outer panel 14 at the front end portion 14C and the rear end portion 14D. Additionally, because of the elastic adhesive G disposed in each of the interstices S, the outer surface of the inner panel 16 at the front end portion 16C and the rear end portion 16D (excluding the projecting portions 18) and the inner surface 14B of the outer panel 14 at the front end portion 14C and the rear end portion 14D are joined together.

The outer surfaces 18A of the projecting portions 18 have a configuration in which they are not joined to the inner surface 14B of the outer panel 14. Because of this, the extension of the outer panel 14 relative to the inner panel 16 resulting from thermal expansion is not inhibited by the inner panel 16. Furthermore, in the case of the fifth embodiment, the projecting portions 18 may also be projectingly disposed only on the inner surface 14B of the outer panel 14 at the front end portion 14C and the rear end portion 14D rather than on the inner panel 16.

Moreover, in the case of the fifth embodiment, the coefficient of linear expansion of the inner panel 16 may also be greater than the coefficient of linear expansion of the outer panel 14. That is, the outer panel 14 may be also be formed of a carbon fiber reinforced plastic (CFRP) material and the inner panel 16 may also be formed of a metal material such as aluminum alloy, so that the panel joint structure 10 has a configuration in which the inner panel 16 is extended relative to the outer panel 14 by thermal expansion.

The panel joint structure 10 pertaining to the embodiments has been described above on the basis of the drawings, but the panel joint structure 10 pertaining to the embodiments is not limited to what is shown in the drawings and can undergo design changes as appropriate without departing from the gist of the present invention. For example, the panel joint structure 10 pertaining to the embodiments is also applicable to a case where, for example, the inner panel 16 contracts relative to the outer panel 14 in a low-temperature environment and thereafter returns to its original state in a room temperature environment.

Furthermore, the configurations in the first to fifth embodiments are applicable to one another. For example, the projecting portions 18 in the third embodiment may also be projectingly disposed on the outer surface 26A side of the inner wall 26 configuring the lower end portion 14A (the hemmed portion 20) of the outer panel 14 like the projecting portions 18 in the fourth embodiment rather than on the inner surface side of the lower end portion 16A of the inner panel 16.

Furthermore, a case where the panel joint structure 10 pertaining to the embodiments was applied to the front side door 12 was taken as an example and described, but the panel joint structure 10 is not limited to this. For example, the panel joint structure 10 pertaining to the embodiments is also applicable to a rear side door, a back door, a vehicle hood, and a vehicle roof not shown in the drawings.

The disclosure of Japanese Patent Application No. 2013-186306 is, in its entirety, incorporated by reference into the present Description. All publications, patent applications, and technical standards mentioned in the present Description are incorporated by reference into the present Description to the same extent as if such individual publication, patent application, or technical standard was specifically and individually indicated to be incorporated by reference.

1. A panel joint structure comprising:
a first panel member that has a first joint portion;
a second panel member that is formed of a fiber reinforced plastic material having a coefficient of linear expansion different from that of the first panel member and has a second joint portion joined by an elastic adhesive to the first joint portion; and
a projecting portion that is integrally projectingly disposed on the second joint portion and contacts the first joint portion to thereby form an interstice for filling a space between the first joint portion and the second joint portion with the elastic adhesive.

2. The panel joint structure according to claim 1, wherein
the first joint portion is formed on an edge portion of the first panel member,
the second joint portion is formed on an edge portion of the second panel member,
one of either of the first joint portion or the second joint portion is made into a hemmed portion that is folded back and fixed to the other of either of the first joint portion or the second joint portion, and
the projecting portion is disposed inside the hemmed portion.

3. The panel joint structure according to claim 2, wherein projecting portions are integrally projectingly disposed on both faces of the second joint portion so as to allow the first joint portion or the second joint portion to be disposed in a thickness direction center portion inside the hemmed portion.

4. The panel joint structure according to claim 1, wherein the projecting portion slidably contacts the first joint portion so as to maintain its state of contact with respect to the first joint portion even when the first panel member or the second panel member thermally expands.

5. The panel joint structure according to claim 1, wherein plural beads are mixed into the elastic adhesive.
